(19) United States
(12) Patent Application Publication
(10) Pub. No.: US 2016/0082299 A1
(43) Pub. Date: Mar. 24, 2016

(54) SELF CONTAINED FIRE SPRINKLER UNIT

(71) Applicants: Gerold MILLEDGE, Washington, DC (US); Marc SEABROOKS, Amityville, NY (US); Carlos E. MAISONET, JR., Albany, NY (US); Robert L. MILLEDGE, JR., Albany, NY (US)

(72) Inventors: Gerold MILLEDGE, Washington, DC (US); Marc SEABROOKS, Amityville, NY (US); Carlos E. MAISONET, JR., Albany, NY (US); Robert L. MILLEDGE, JR., Albany, NY (US)

(21) Appl. No.: 14/493,517

(22) Filed: Sep. 23, 2014

(51) Int. Cl. A62C 35/02

(52) U.S. Cl. CPC A62C 35/023

(57) ABSTRACT

A system for delivering fluid, in some embodiments, for suppressing fires is provided. The system may include a main tank forming a cavity for receiving a fluid, wherein the main tank provides an air inlet valve and a fluid outlet line in communication with the cavity yet both are separately connectable to components external to the cavity. The air inlet valve may be operably connected to an air compressor, while the fluid outlet line may be connected to an adaptable piping apparatus that terminates in at least one sprinkler head. The piping apparatus may be configured and adapted to provided a non-intrusive and in expensive fluid delivery system.

### BACKGROUND OF THE INVENTION

The present invention relates to fire suppression and, more particularly, to a non-invasive, cost effective and easy to install fire suppression system.

Fires kill thousands of people and cost millions in property damage each year. Installing sprinkler systems would surely save lives and property, yet because they are so prohibitively expensive and/or structurally invasive the general public opts against installation, resulting in innumerable injuries and damages that could have been prevented.

Hard-lined sprinkler systems are well known for more than a century now, and work well in regard to saving human life and property. Where they fail is that they are financially and/or architecturally impractical safety solution for many new and existing homes, college dorms, apartments, other living/work spaces such as RVs, mobile homes, warehouses and other storage spaces.

As can be seen, there is a need for a cost-effective, non-invasive sprinkler system.

### SUMMARY OF THE INVENTION

In one aspect of the present invention, a system for inexpensively and non-invasively installing a fire suppression apparatus, comprises: a main tank forming a cavity for receiving a fluid, wherein the main tank has a first side and an opposing second side; a fluid outlet line having a cavity end and an external end, wherein the external end projects from the first side and the cavity end extends into the cavity near the second side; an air inlet valve provided by the first side, wherein the air inlet valve is in communication with the cavity; and at least one sprinkler head connected to the external end.

In another aspect of the present invention, a method of installing an inexpensive and non-invasive fire suppression system, comprises the steps of: providing a main tank forming a cavity for receiving a fluid; providing a fluid outlet line having a cavity end and an external end; journaling the fluid outlet line through a first side of a main tank so that the cavity end extends into the cavity; journaling an air inlet valve through the first side so as to communicate with the cavity; and creating an air-tight seal between the first side and the fluid outlet line and the first side and the air inlet valve.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a section view of an exemplary embodiment of the present invention, taken along line 2-2 in FIG. 1, illustrating pre-operation thereof; and

FIG. 3 is a section view of an exemplary embodiment of the present invention, illustrating operation thereof.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for delivering fluid, in some embodiments, for suppressing fires. The system may include a main tank forming a cavity for receiving a fluid, wherein the main tank provides an air inlet valve and a fluid outlet line in communication with the cavity yet both are separately connectable to components external to the cavity. The air inlet valve may be operably connected to an air compressor, while the fluid outlet line may be connected to an adaptable piping apparatus that terminates in at least one sprinkler head. The piping apparatus may be configured and adapted to provided a non-intrusive and in expensive fluid delivery system.

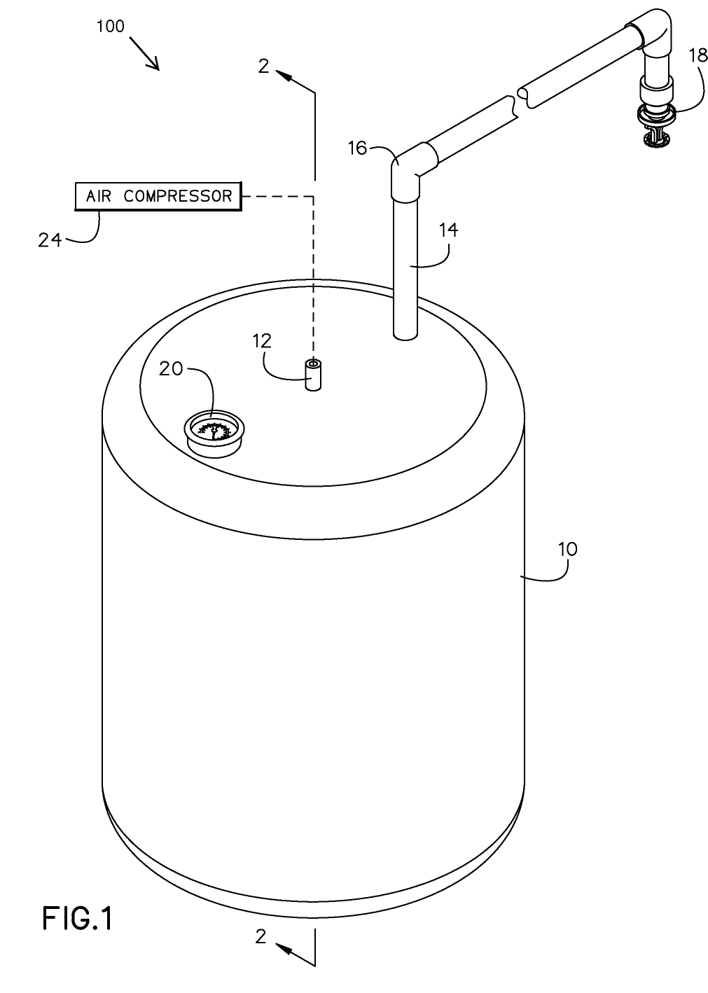

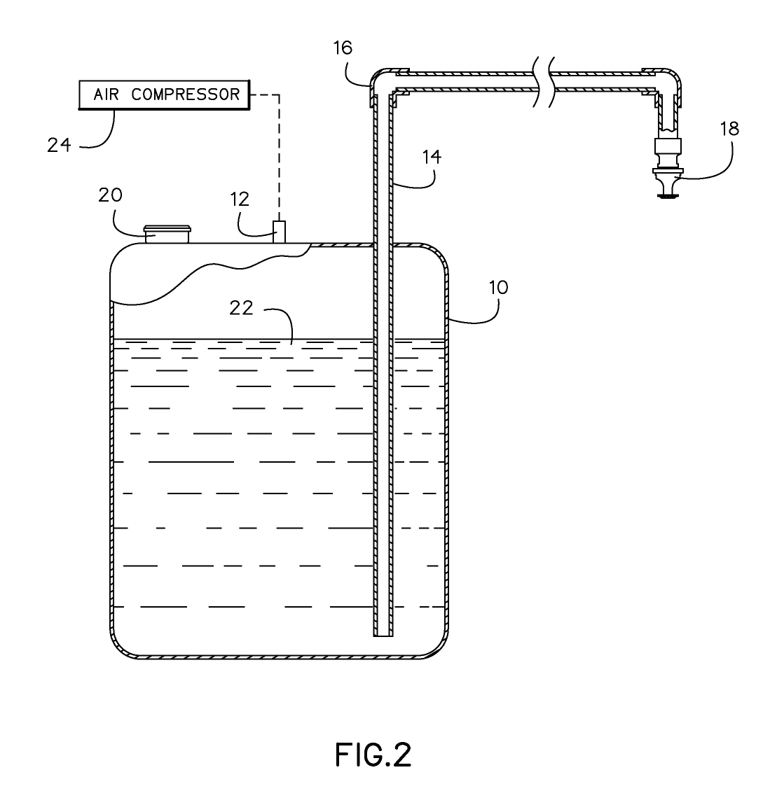

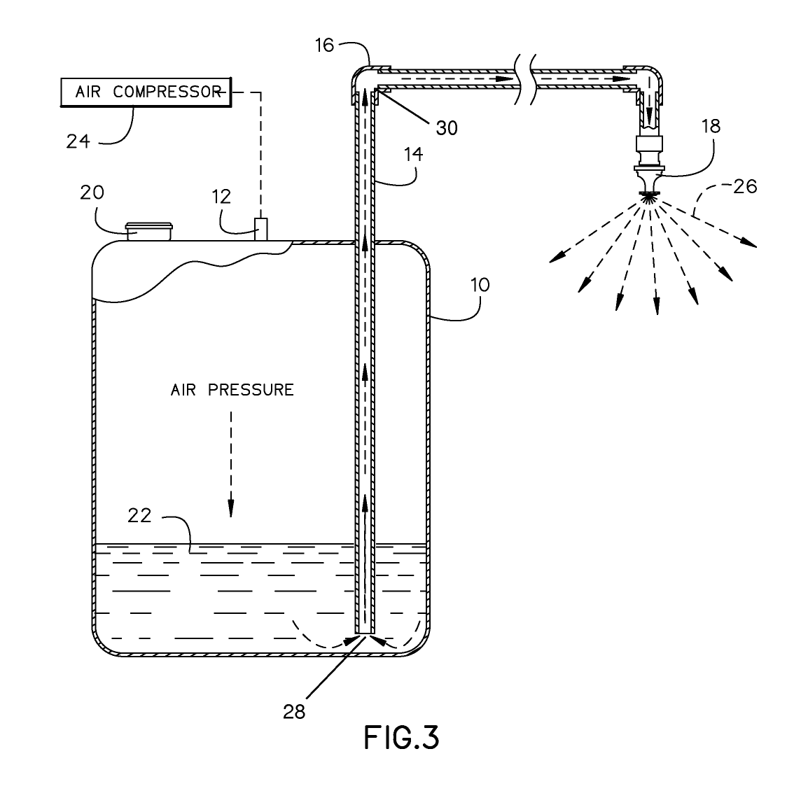

Referring to FIGS. 1 through 3, the present invention may include a fluid delivery system 100 having main tank 10 forming a cavity for receiving a fluid 22, wherein the main tank 10 provides an air inlet valve 12 and a fluid outlet line 14 that both project from an external surface of the main tank 10 while being in communication with the cavity through a first side of the main tank 10. The fluid outlet line 14 may have a pipe-like structure having a cavity end 28 and an external end 30 designed to transmit the fluid 22 therethrough. The fluid outlet line 14 may extend into the cavity so that the cavity end 28 terminates near a second side of the main tank 10. The second side is understood to be the side of the main tank 10 that is furthest from the first side of the main tank 10 providing the air inlet valve 12. The external end 30 may be connected to a configurable piping apparatus 16. The piping apparatus 16 may be adapted to transmit the fluid 22 from the fluid outlet line 14 therethrough and then to at least one sprinkler head 18. The at least on sprinkler head 18 may be designed to deliver the fluid 22 in the form of a spray field 26 adapted to suppress nearby fires. The at least one sprinkler head 18 may provide a specific heat rating, whereby the sprinkler head 18 activates when a predetermined temperature threshold has been met or exceeded. The air inlet valve 12 may be operably connected to an air compressor 24 adapted to supply air pressure to the cavity so that the fluid 22 therein may be urged through the fluid outlet line 14. The main tank 10 may provide an air pressure gauge 20 adapted to determine the air pressure within a portion of the cavity.

The main tank 10 may be sized and dimensioned to adapt to various in-situ installations. The main tank 10 may be made of material of strength sufficient to withstand the hydraulic and air pressure so that the main tank 10 functions in accordance with the present invention as described herein.

The piping apparatus 16 may include a plurality of connectable and configurable piping elements, such as but not limited to elbows, tees, elongated pipes, fittings, branches, and the like, that can be arranged so that the at least on sprinkler head 18 functions in accordance with the present invention as described herein. The fluid 22 may include water, chemical solutions and the like that have fire suppression properties.

A method of using the invention may include the following. The components of the fluid delivery system 100 disclosed above may be provided. A user may fashion the main tank 10 from any suitably sized container that forms air-tight and water-tight cavity. The user may then puncture a first side of the main tank 10 twice, to create a suitable sized opening to accommodate the air inlet valve 12 and, separately, a suitable sized opening to accommodate the fluid outlet line 14 so they both communicate with the cavity. The user may slide the outlet line 14 through its respective opening so that its cavity end 28 protrudes into the cavity near the second side of the main tank 10 opposite the first side. Thereafter the user may seal the separate openings about the inlet valve 12 and the outlet line 14, respectively, so as to maintain the air-tight and water-tight cavity. Then the user may fashion the piping apparatus 16 so that the at least one sprinkler head 18 is positioned in at least one desired location. The user may then fill the cavity with a predetermined amount of fluid 22. The user may then operably connect the air inlet valve 12 to the external air compressor 24 so as to fill the cavity with a predetermined amount of air through the air inlet valve via the compressor 24, that may be constantly gauged by the air pressure gauge 20. As the cavity fills with air, the resulting air pressure urges the fluid 22 up through the outlet line 14, through the piping apparatus 16 and to the at least one sprinkler head 18 where it remains until the at least one sprinkler head 18 is activated, the fluid delivery system 100 is now charged (powered).

The fluid delivery system 100 is activated when at least one sprinkler head 18 determines the predetermined heat threshold has been met or exceeded. The at least one activated sprinkler head 18 no longer resists the fluid 22 being forced through the piping apparatus 16, resulting in the spray field(s) 26 through the at least one sprinkler head 18.

The air pressure gauge 20 may be utilized through this process for the user to gauge the amount of air going into the cavity, provide a constant visual representation of the air pressure maintained in the cavity at all times, including during initial fill, once charged, when activated and when the fluid 22 has been depleted from within cavity.

The piping apparatus 16 and so the at least one sprinkler head 18 may be configured to provided a non-intrusive and in expensive fire suppression system. In certain embodiments, the fluid delivery system 100 may be configured to provide a stand-alone shower, water supply and the like. The fluid delivery system 100 may provide a portable means of all of the above.

It should be understood, of course, that the foregoing relates to exemplary embodiments of the invention and that modifications may be made without departing from the spirit and scope of the invention as set forth in the following claims.

What is claimed is:

1. A system for inexpensively and non-invasively installing a fire suppression apparatus, comprising:
a main tank forming a cavity for receiving a fluid, wherein the main tank has a first side and an opposing second side;
a fluid outlet line having a cavity end and an external end, wherein the external end projects from the first side and the cavity end extends into the cavity near the second side;
an air inlet valve provided by the first side, wherein the air inlet valve is in communication with the cavity; and
at least one sprinkler head connected to the external end.

2. The system of claim 1, further providing a piping apparatus interconnecting the air inlet valve and the at least one sprinkler head.

3. The system of claim 1, further providing an air pressure gauge on the main tank configured to gauge the air pressure within the cavity.

4. The system of claim 1, further providing the fluid in the cavity.

5. The system of claim 4, wherein the fluid is water.

6. The system of claim 4, wherein the fluid is a combination of water and fire suppression chemicals.

7. The system of claim 1, further providing an air compressor operably connected to the air inlet valve.

8. A method of installing an inexpensive and non-invasive fire suppression system, comprising the steps of:
providing a main tank forming a cavity for receiving a fluid;
providing a fluid outlet line having a cavity end and an external end;
journaling the fluid outlet line through a first side of a main tank so that the cavity end extends into the cavity;
journaling an air inlet valve through the first side so as to communicate with the cavity; and
creating an air-tight seal between the first side and the fluid outlet line and the first side and the air inlet valve.

9. The method of claim 8, further including filling the cavity with a predetermined amount of fluid.

10. The method of claim 8, further providing connecting at least one sprinkler head to the fluid outlet line.

11. The method of claim 10, further including operably connecting an air pressure gauge to the first side.

12. The method of claim 10, further including operably connecting an air compressor to the air inlet value and pressurizing the cavity with a predetermined amount of air pressure.

13. The method of claim 10, further providing interconnecting the at least one sprinkler head and the fluid outlet line with a piping apparatus configured to be non-invasive for a predetermined living space.

14. The method of claim 8, wherein the cavity end terminates near the second side within the cavity.
